(19) United States
(12) Patent Application Publication
(10) Pub. No.: US 2018/0084946 A1
(43) Pub. Date: Mar. 29, 2018

(54) OUTDOOR COOKER AND SYSTEM FOR DETECTING AND REACTING TO OVER-TEMPERATURE EVENTS

(71) Applicant: W.C. Bradley Co., Columbus, GA (US)

(72) Inventors: Alex Gafford, Midland, GA (US); Chris Bennett, Opelika, AL (US)

(21) Appl. No.: 15/709,604

(22) Filed: Sep. 20, 2017

Related U.S. Application Data
(60) Provisional application No. 62/401,260, filed on Sep. 29, 2016.

(51) Int. Cl. A47J 37/07

(52) U.S. Cl. CPC A47J 37/0786; A47J 37/0713

(57) ABSTRACT

An outdoor cooking system having at least one temperature sensor which senses an internal temperature of the cooking chamber or a temperature of the cooking chamber exhaust gas stream and transmits the temperature reading to a control unit which determines whether an over-temperature condition exists and then transmits an over-temperature alert and/or reduces or stops the heat output of the cooker heating elements.

### RELATED CASE

This application claims the benefit of U.S. Provisional Patent Application Ser. No. 62/401,260 filed on Sep. 29, 2016 and incorporates said provisional application by reference into this document as if fully set out at this point.

### FIELD OF THE INVENTION

The present invention relates to outdoor cookers. More particularly, the present invention relates to systems and methods for automatically detecting and reacting to flare-ups, fires, and other over-temperature events in outdoor cookers.

### BACKGROUND OF THE INVENTION

In the past ten years, numerous cooking appliances have been developed which are equipped with on-board electronic displays and/or remote displays which provide textual or graphical information relative to the status of the food being cooked. In some cases, the temperature of the food being cooked is monitored over time and the temperature is displayed with respect to a target temperature set by the user. This information is displayed in many cases as a pair of numerical values or as a graph of temperature versus time. In other cases, the display provides a numerical cooking timer indicating the amount of time remaining until the product is expected to be done.

In addition, it has also been proposed that gas grills be equipped with semi-automated heating and/or cooking control systems which can be digitally connected to Smart devices such as tablets, cell phones, and the like. An example of one such system for an outdoor grill is shown and described in US2016/0037966 to Chin et. al. In the grill control system described in US 2016/0037966, each of the individual burners contained in the grill is equipped with its own independent, automated electric control valve and temperature instrument system for controlling the rate of gas flow delivered to the burner.

However, although systems such as those described above are being developed for remotely monitoring and/or controlling the cooking operations performed in outdoor cookers, a significant need remains for an automated system and method for detecting and reacting to over-temperature events which commonly occur when using outdoor cookers. An automated system and method for detecting and reacting to over-temperature events is particularly needed, for example, for situations where (a) the user is relying on a remote monitoring and/or cooking control system and is therefore not positioned within sight of the cooker or (b) the user has stepped away from the cooker for other reasons.

As used herein and in the claims, the term “over-temperature event” refers to any type of occurrence in the cooker where the temperature at the cooking grate or at some other location in the cooking chamber, or the temperature of the cooking chamber exhaust, exceeds the normal maximum operating temperature of the cooker at the location in question by at least 250° F.

By way of example, but not by way of limitation, it is well known that in gas-fueled barbecue grills and other outdoor cookers, flaring and other over-temperature events can occur when liquid fat from meat products drips onto a heating element, burner flame, or other surface within the heating chamber, or on the cooking grate, which is hot enough to cause the liquid fat to ignite. Fires can also result from the build-up over time of fat or other flammable cooking residues on the cooking grate or elsewhere in the cooker.

Tests have shown that, for a gas grill operating at a high cooking temperature of 650° F. at the cooking grate, the temperature of the combustion gas vented from the grill will typically be slightly over 500° F. However, under flaring conditions, the temperature of the vent gas can be as much as 800° F. or more and can climb to as much as 900° F. or higher as the severity of the condition increases.

Over-temperature events, if not quickly addressed, can burn, scorch, or severely char the food being cooked. Moreover, over-temperature conditions resulting from flaring or other fire conditions in the cooker, if not controlled, can escalate to the point of causing damage to the cooker itself or to adjacent structures such as patio covers or the user's home or garage.

Heretofore, rather than developing effective and reliable systems for automatically detecting and quickly stopping over-temperature events when they occur, the efforts of grill manufactures and others in the industry have instead been generally focused on the development of design improvements in outdoor cookers which are intended to reduce the occurrence of flare-ups or other fire events during the cooking operation. However, experience has shown that even in the most sophisticated outdoor cooking systems, flaring and other over-temperature events can still occur from time to time if the cooker is not closely monitored.

### SUMMARY OF THE INVENTION

The present invention satisfies the needs and alleviates the problems discussed above.

In one aspect, there is provided an outdoor cooking system which preferably comprises: (a) a cooker housing having an interior, (b) a lid having an interior, the lid being positionable on the cooker housing and the interior of the cooker housing together with the interior of the lid defining a cooking chamber of the outdoor cooking system when the lid is positioned on the cooker housing; (c) one or more heating elements in the interior of the cooker housing; (d) a food support structure in the cooking chamber above the one or more heating elements; (e) at least one temperature sensor which is positioned to sense, and which automatically transmits a temperature signal indicating, an internal temperature of the cooking chamber at a location above the one or more heating elements or a temperature of a cooking chamber exhaust gas stream; and (f) a control unit.

The control unit in this outdoor cooking system preferably automatically receives the temperature signal from the temperature sensor and then automatically determines whether an over-temperature condition exists based at least in part upon the internal temperature of the cooking chamber or the temperature of the cooking chamber exhaust gas stream sensed by the temperature sensor. When an over-temperature condition exists, the control unit also preferably either transmits on over-temperature alert, reduces a heat output of the one or more heating elements, stops the heat output of the one or more heating elements, or a combination thereof.

In another aspect, there is provided an outdoor cooking system which preferably comprises: (a) a cooker housing having an interior; (b) a lid having an interior, the lid being positionable on the cooker housing and the interior of the cooker housing together with the interior of the lid defining a cooking chamber of the outdoor cooking system when the lid is positioned on the cooker housing; (c) one or more heating elements in the interior of the cooker housing; (d) a food support structure in the cooking chamber above the one or more heating elements; (e) at least one temperature sensor which is positioned to sense, and which automatically transmits a temperature signal indicating, an internal temperature of the cooking chamber at a location above the one or more heating elements or a temperature of a cooking chamber exhaust gas stream; and (f) a control unit comprising a processing unit and a program code which is embodied on a computer readable storage component.

The control unit in this outdoor cooking system preferably automatically receives the temperature signal from the temperature sensor and the program code embodied on the computer readable storage component is readable by the processing unit to then automatically determine whether an over-temperature condition exists based at least in part upon the internal temperature of the cooking chamber or the temperature of the cooking chamber exhaust gas stream sensed by the temperature sensor. Also, in accordance with the program code, when an over-temperature condition exists, the control unit preferably automatically transmits on over-temperature alert, reduces a heat output of the one or more heating elements, stops the heat output of the one or more heating elements, or a combination thereof.

Further aspects, features, and advantages of the present invention will be apparent to those in the art upon examining the accompanying drawings and upon reading the following Detailed Description of the Preferred Embodiments.

### BRIEF DESCRIPTION OF THE DRAWINGS

FIG. 1 is a front perspective view of an embodiment 100 of the inventive outdoor cooking system with the lid 106 thereof in open position.

FIG. 2 is a rear perspective view of the inventive outdoor cooking system 100 with the lid 106 closed.

FIG. 3 schematically illustrates the inventive outdoor cooking system 100.

FIG. 4 schematically illustrates an embodiment 134 of a control unit used in the inventive outdoor cooking system 100.

FIG. 5 schematically illustrates and alternative embodiment 200 of the inventive outdoor cooking system.

FIG. 6 is a flow chart of a program code embodied and used in the control unit 134 of the inventive outdoor cooking system 100.

### DETAILED DESCRIPTION OF THE PREFERRED EMBODIMENTS

The cooker used in the inventive outdoor cooking system can be a convective cooker, a radiant (i.e., infrared) cooker, or a combination convective and radiant cooker. The cooker can also be a cooker of a type used only for cooking or can be of a type used for both cooking and smoking. In addition, the cooker can be heated using any desired type of heating element(s) including, but not limited to, one or more gas fuel burners or gas fuel heating elements, one or more electric heating elements, or one or more gas infrared burners.

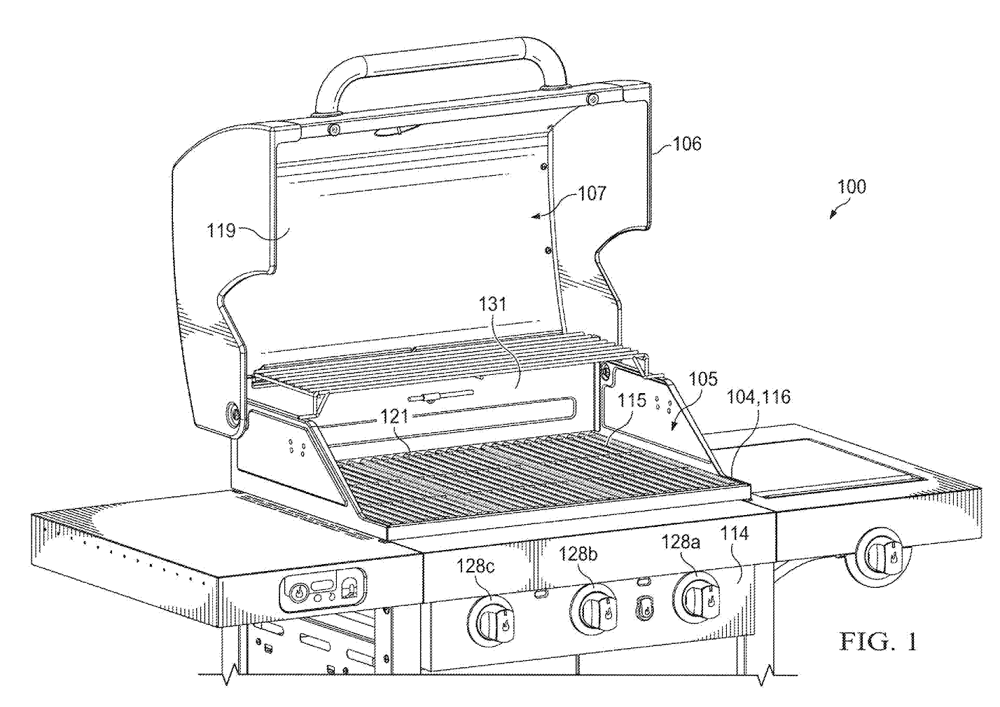

A gas-fueled embodiment 100 of the inventive outdoor cooking system cooker is illustrated in FIGS. 1-4. The inventive cooker 100 comprises a lower cooker housing 104 and a pivotable lid 106 for opening and closing the top opening 116 of the cooker housing 104. When the lid 106 is positioned on the cooker housing 104, the interior 105 of the cooker housing and the interior 107 of the lid 106 together define an interior cooking chamber 108 of the cooking system 100.

The outdoor cooking system 100 further comprises: one or more (preferably a plurality of) individual burner assemblies 110a, 110b, 110c having burner elements 112a, 112b, 112c positioned within the interior 105 of the cooker housing 104; at least one vent opening 111 for venting a cooking chamber exhaust gas stream 113 comprising combustion and/or cooking gases from the cooking chamber 108; one or more removable cooking grates or other food support structure(s) 115 positioned in the cooking chamber 108 above the burner elements 112a, 112b, 112c and preferably positioned at or near the top opening 116 of the cooker housing 104; a front control panel 114; at least one over-temperature sensor 117 positioned for sensing an over-temperature event in the inventive cooking system 100; and an inventive automated over-temperature detection and reaction system 125.

In addition, although not shown, it will be understood that lava rocks, burner shields, one or more infrared emitter plates, or similar elements or structures employed in gas grills or in gas infrared cookers can also be installed in the cooking chamber 108 between the burner elements 112a, 112b, 112c and the food support structure 115.

By way of example, but not by way of limitation, the at least one vent opening 111 for the cooking chamber 108 will preferably be located in the back of the cooker and will preferably be (a) one or more slots or louvers, preferably horizontal, provided in an upwardly extending back wall 131 of the lower cooker housing 104, (b) one or more slots or louvers, preferably horizontal, provided in the back wall 123 of the lid 106, or (c) a gap, preferably horizontal, formed between the upper end of the upwardly extending back wall 131 of the cooker housing 108 and the lower end of the back wall 123 of the lid 106. The vent opening(s) 111 is/are also preferably located at an elevation which is at or above, preferably above, the elevation of the top 121 of the food support structure 115.

The over-temperature sensor 117 can be a thermocouple or any other type of temperature sensor known in the art. The over-temperature sensor 117 is preferably positioned in a vent opening 111 of the cooking chamber 108, or is otherwise located in the cooking chamber 108 in sufficient proximity to the vent opening(s) 111, so that the over-temperature sensor 117 is positioned in, and thus will automatically sense the temperature of, the cooking chamber exhaust gas stream 113. The over-temperature sensor 117 will preferably be secured to the upwardly extending back wall 131 of the cooker housing 104 at a location which is (a) inside the cooking chamber 108 and (b) not more than 4 inches, more preferably not more than 2 inches, from a vent opening 111.

If only one over-temperature sensor 117 is used, the sensor 117 will preferably be position at the midpoint of the lateral (i.e., side to side) width of the cooking chamber 108. If more than one over-temperature sensor 117 is used, the sensors 117 will preferably be evenly spaced along the lateral width of the cooking chamber 108. Thus, for example, if two over-temperature sensors 117 are used, one of the sensors 117 will preferably be positioned at one-third of the lateral distance from the right side to the left side of the cooking chamber 108 and the other sensor 117 will preferably be positioned at two-thirds of the lateral distance from the right side to the left side of the cooking chamber 108.

It will be understood, however, that the one or more over-temperature sensors 117 could alternatively be positioned at other locations in the cooking chamber 108, preferably above the one or more heating elements 112a, 112b, 112c for sensing a cooking chamber temperature during the cooking process. As one example, an over-temperature sensor 117 could be positioned at a location in the range of from about 1 to about 6 inches above the center of the food support structure 115. As another example, an over-temperature sensor 117 could hang downwardly a distance of from about 4 to about 8 inches from the upper interior wall 119 of the lid 106 above the center of the food support structure 115.

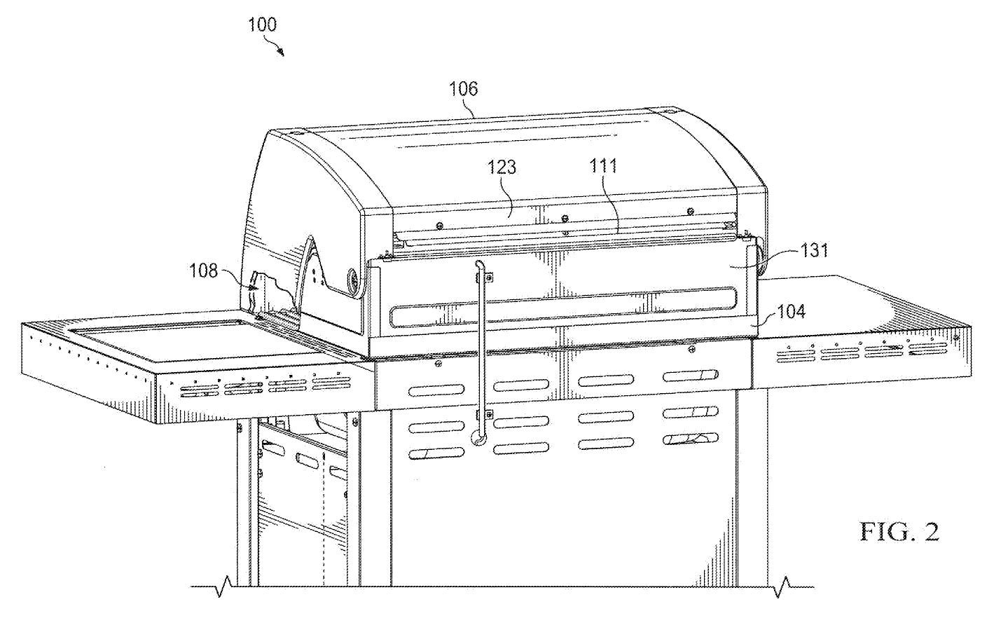

Each of the one or more over-temperature sensors 117 can be a wired sensor, as illustrated in FIG. 2, or a wireless sensor for automatically transmitting to the automated over-temperature detection and reaction system 125 a temperature signal 133 indicating the cooking chamber temperature or the exhaust gas temperature measured by the sensor 117. It will be understood, however, that the temperature reading obtained and transmitted by the sensor(s) 117 can also be used for other purposes such as, for example, continuously monitoring cooking conditions and/or automatically controlling the cooking process.

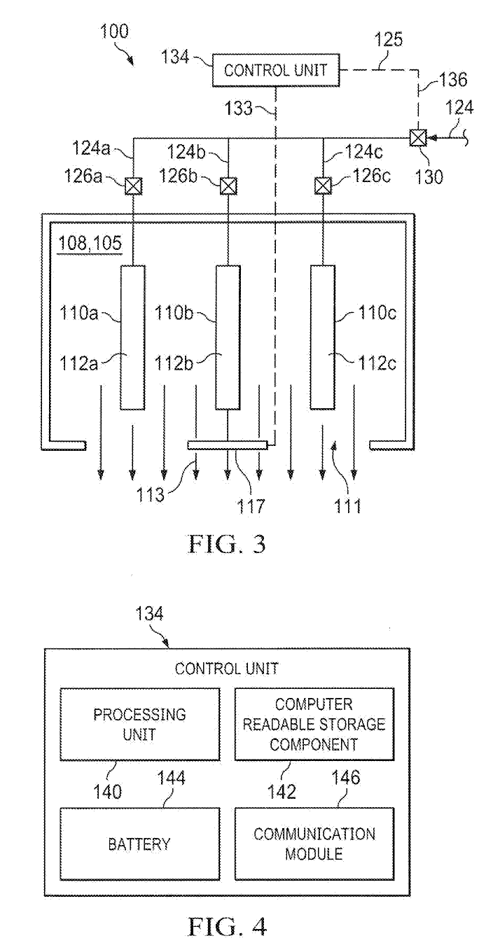

Each of the burner assemblies 110a, 110b, 110c used in the inventive cooker 100 can be a tube burner assembly, a pan burner assembly, a box burner assembly, an infrared burner assembly, or generally any other type of gas fuel burner assembly or element known in the art. Each of the gas burner assemblies 110a, 110b, and 110c illustrated in FIG. 3 is a tube burner assembly which comprises: a tube burner element 112a, 112b, or 112c which extends from front to back through a lower or mid portion of the interior 105 of the cooker housing 104; a fuel inlet 124a, 124b, or 124c for delivering propane or other suitable gas fuel from a main fuel supply manifold or line 124 to the burner element 112a, 112b, or 112c; a manual control valve 126a, 126b, or 126c included in the individual fuel inlet 124a, 124b, or 124c for manually controlling the fuel rate and for manually shutting off the flow of fuel to the burner element 112a, 112b, or 112c; and a hand knob or dial 128a, 128b, or 128c for operating the manual control valve 126a, 126b, or 126c.

The main fuel supply line, tube, manifold or other conduit 124 delivers the gas fuel to the inventive cooker 100 from a propane tank or other gas fuel supply source (not shown). The hand knobs 128a, 128b, and 128c for operating the manual control valves 126a, 126b, and 126c are preferably located on the front control panel 114 of the inventive cooker 100.

As illustrated in FIG. 3, the embodiment 125 of the inventive automated over-temperature detection and reaction system 125 used in the outdoor cooking system 100 preferably comprises: (a) an over-temperature valve 130 located in the main fuel supply conduit 124 upstream of the individual burner fuel supply inlets 124a, 124b, 124c and upstream of the individual burner control valves 126a, 126b, 126c and (b) a control unit 134.

The over-temperature valve 130 can be any type of electric valve capable of automatically shutting off or reducing the gas fuel rate to the cooking system 100. Examples of suitable electric control valves include, but are not limited to, electric solenoid valves, electric proportioning solenoid valves, motor driven linear or rotary valves, or variable pressure controlling devices. It will also be understood that, in addition to being used in the inventive outdoor cooking system 100 for reacting to over-temperature conditions, the valve 130 can optionally be a valve which is shared with other systems which may be used in the inventive cooking system 100 such as, for example, an automated cooking control system or a shut-down system for dealing with a loss of burner flame or other scenarios.

The control unit 134 of the automated over-temperature detection and reaction system 125 automatically receives the electronic temperature signal(s) 133 transmitted by the over-temperature sensor(s) 117. The control unit 134 can include any desired type and/or number of components wherein, for example (a) the components comprise separate, electronically linked modules which are located together or at different locations in the inventive cooking system 100 or (b) the components are located together and electronically linked on a single circuit board or (c) the components are otherwise located together in a single piece of hardware. It will also be understood, however, that at least some of the components of the control unit 134, and/or the functions thereof, can alternatively be located or performed (1) in the World Wide Web using a remote server or the cloud, (2) in a hand held remote, (3) in an app for a smart phone or a tablet, (4) in other hand held devices, (5) etc.

As illustrated in FIG. 4, the control unit 134 preferably comprises a microprocessor or other computer processing unit 140. By way of example, but not by way of limitation, the control unit 134 can also include: a computer readable medium, device, or other storage component 142 which is readable by the processing unit 140; a battery 144 and/or a power cord for powering the control unit 134 and the other electrical components of the automated over-temperature detection and reaction system 125; and a Bluetooth, radio frequency, infrared, Wi Fi, wired, and/or other communication module 146.

The control unit 134 preferably contains and implements programmed instructions for automatically analyzing the temperature signal 133 which it receives from the over-temperature sensor 117 to determine whether an over-temperature condition exists and then, if it is determined that an over-temperature event is occurring, either (a) transmitting an over-temperature alert to the user's phone, remote, or other device, (b) sending an electric current or other electronic signal 136 to the over-temperature valve 130 to partially close the valve 130 and thus reduce the combustion rate and heat output of the burner elements 112a, 112b, and 112c, (c) sending an electric current or other electronic signal 136 to the over-temperature valve 130 to fully close the valve 130, thus shutting off all gas flow and stopping the heat output of the burner elements 112a, 112b, and 12c, or (d) performing two or more of these actions simultaneously or in sequence. Unless closed or partially closed by the control unit 134, the over-temperature valve 130 will preferably remain in a fully open position.

The control logic program or routines (i.e., the program code) for this automated over-temperature detection and reaction procedure can be stored (i.e., embodied) on the computer readable storage component 142 of the control unit 134. Alternatively, as indicated above, some or all of these programmed procedures or portions thereof can be located or performed elsewhere in the inventive outdoor cooking system 100 such as, in the World Wide Web using a remote server or the cloud, in a hand held remote, in an app for a smart phone or a tablet, in other hand held devices, etc.

In determining whether an over-temperature condition exists based at least in part on the temperature signal 133 indicating an internal temperature of the cooking chamber 108 or the temperature of the exhaust gas stream 113, the programmed procedure of the control unit 134 could use a variety of techniques. As one example, the control unit 134 could determine whether the measured temperature meets or exceeds an over-temperature reaction set point (e.g., preferably 800° F.). As another example, the control unit 134 could compute the rate of increase of temperature and react to a rate of change greater than 250° F. in 30 seconds.

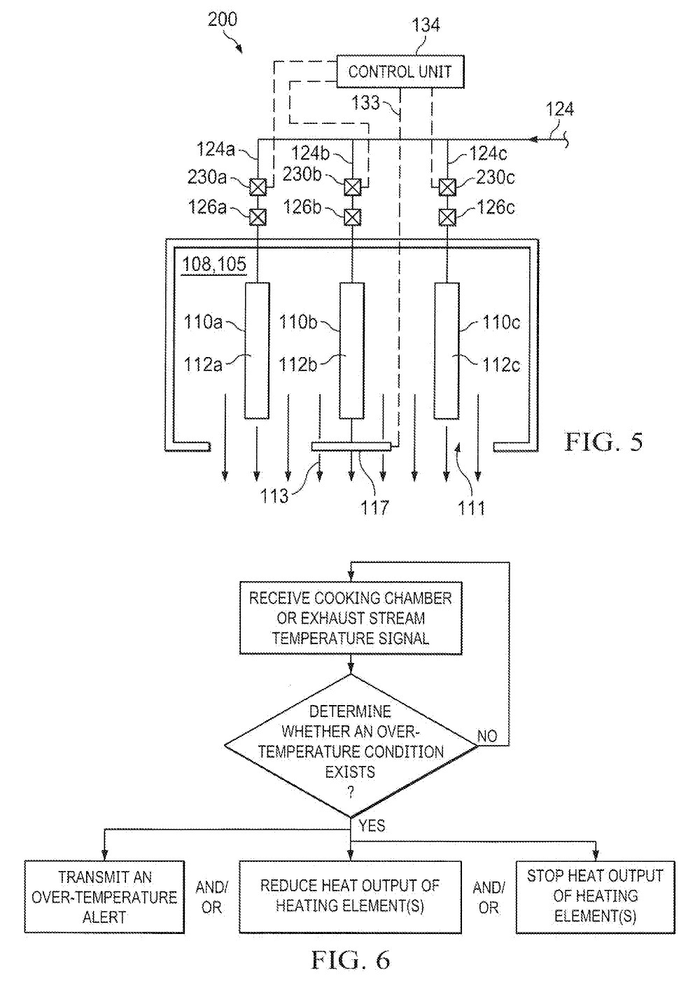

An alternative embodiment 200 of the inventive outdoor cooking system is illustrated in FIG. 5. The inventive cooking system 200 is identical to the outdoor cooking system 100 illustrated in FIG. 3 except that, rather than using only a single over-temperature valve 130, the cooking system 200 uses separate, individual over-temperature valves 230a, 230b, and 230c installed in the burner element fuel inlets 124a, 124b, and 124c. The over-temperature valves 230a, 230b, and 230c (a) can be unitary valves capable of being both automatically and manually operated, which replace the manual valves 126a, 126b, and 126c or (b) can be automated valves which are preferably positioned upstream of the burner manual control valves 126a, 126b, and 126c.

Consequently, in the alternative cooking system 200, when the control unit 134 of the cooking system 200 determines that an over-temperature condition exists, the control unit 134 will automatically either (a) transmit an over-temperature alert to the user's phone, remote, or other device, (b) send an electric current or other electronic signal to each of the individual over-temperature valves 230a, 230b, and 230c to partially close each of the valves the 230a, 230b, and 230c and thus reduce the combustion rate and heat output of the burner elements 112a, 112b, and 112c, (c) send an electric current or other electronic signal to each of the individual over-temperature valves 230a, 230b, and 230c to fully close each of the valves the 230a, 230b, and 230c, thus shutting off all gas flow and stopping the heat output of the burner elements 112a. 112b, and 112c, or (d) performing two or more of these actions simultaneously or in sequence. Unless closed or partially closed by the control unit 134, each of the over-temperature valves 230a, 230b, and 230c will preferably remain in a fully open position.

It will additionally be understood that the individual over-temperature or control valves 230a, 230b, and 230c can also or alternatively be used along with the temperature reading(s) obtained and transmitted by the sensor(s) 117 for other purposes, such as, for example, continuously monitoring cooking conditions and/or automatically controlling the cooking process.

For each embodiment 100 and 200 of the inventive cooking system, an example of a preferred program code which can be embodied on the computer readable storage component 142 of the control unit 134 is illustrated in FIG. 6. In accordance with the program code shown in FIG. 6, the control unit 134 continuously operates to (a) automatically determine whether an over-temperature condition exists based at least in part upon the internal temperature of the cooking chamber 108 or the temperature of the cooking chamber exhaust gas stream 113 sensed by the temperature sensor 117 and, when an over-temperature condition exists, (b) automatically transmit on over-temperature alert, reduce a heat output of the of the one or more heating elements (e.g., by partially closing the over-temperature valve 130 of system 100 or all of the individual over-temperature valves 230a, 230b, and 230c of the system 200), stop the heat output of the one or more heating elements (e.g., by fully closing the over-temperature valve 130 of system 100 or all of the individual over-temperature valves 230a, 230b, and 230c of the system 200), or a combination thereof.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within this invention as defined by the claims.

What is claimed is:

1. An outdoor cooking system comprising:
a cooker housing having an interior;
a lid having an interior, the lid being positionable on the cooker housing and the interior of the cooker housing together with the interior of the lid defining a cooking chamber of the outdoor cooking system when the lid is positioned on the cooker housing;
one or more heating elements in the interior of the cooker housing;
a food support structure in the cooking chamber above the one or more heating elements;
at least one temperature sensor which is positioned to sense, and which automatically transmits a temperature signal indicating, an internal temperature of the cooking chamber at a location above the one or more heating elements or a temperature of a cooking chamber exhaust gas stream; and
a control unit which automatically (a) receives the temperature signal from the temperature sensor, (b) determines whether an over-temperature condition exists based at least in part upon the internal temperature of the cooking chamber or the temperature of the cooking chamber exhaust gas stream sensed by the temperature sensor, and, when an over-temperature condition exists, (c) transmits on over-temperature alert, reduces a heat output of the of the one or more heating elements, stops the heat output of the one or more heating elements, or a combination thereof.

2. The outdoor cooking system of claim 1 further comprising:
the cooking chamber having a vent opening for the cooking chamber exhaust gas stream and
the temperature sensor being located in the vent opening or in the cooking chamber exhaust gas stream within the cooking chamber upstream of the vent opening.

3. The outdoor cooking system of claim 2 further comprising the temperature sensor being attached to an interior side of an upwardly extending back wall of the cooker housing at an elevation which is higher than the food support structure.

4. The outdoor cooking system of claim 2 wherein the vent opening comprises one or more slots or louvers in an upwardly extending back wall of the cooker housing.

5. The outdoor cooking system of claim 2 wherein the vent opening comprises a gap between (a) an upper end of an upwardly extending back wall of the cooker housing and (b) a lower end of a back wall of the lid.

6. The outdoor cooking system of claim 1 wherein:
the one or more heating elements are a plurality of gas fuel burners or burner elements, each of the gas fuel burners or burner elements having a gas fuel inlet which includes a manual control valve;
the outdoor cooking system further comprises a gas fuel supply conduit which supplies a gas fuel to the gas fuel inlets of the gas fuel burners or burner elements and an over-temperature valve in the gas fuel supply conduit upstream of all of the manual control valves; and
when the control unit determines that an over-temperature condition exists, the control unit automatically operates to partially close or fully close the over-temperature valve.

7. The outdoor cooking system of claim 6 wherein, when the control unit determines that an over-temperature condition exists, the control unit automatically operates to fully close the over-temperature valve.

8. The outdoor cooking system of claim 6 wherein the over-temperature valve is an electric solenoid valve.

9. The outdoor cooking system of claim 1 wherein:
the one or more heating elements are a plurality of gas fuel burners or burner elements, each of the gas fuel burners or burner elements having a gas fuel inlet which includes an over-temperature valve and
when the control unit determines that an over-temperature condition exists, the control unit automatically operates to partially close or fully close the over-temperature valves of the plurality of gas fuel burners or burned elements.

10. An outdoor cooking system comprising:
a cooker housing having an interior;
a lid having an interior, the lid being positionable on the cooker housing and the interior of the cooker housing together with the interior of the lid defining a cooking chamber of the outdoor cooking system when the lid is positioned on the cooker housing;
one or more heating elements in the interior of the cooker housing;
a food support structure in the cooking chamber above the one or more heating elements;
at least one temperature sensor which is positioned to sense, and which automatically transmits a temperature signal indicating, an internal temperature of the cooking chamber at a location above the one or more heating elements or a temperature of a cooking chamber exhaust gas stream; and
a control unit which automatically receives the temperature signal from the temperature sensor, the control unit comprising a processing unit and a program code which is embodied on a computer readable storage component and is readable by the processing unit to cause the control unit to (a) automatically determine whether an over-temperature condition exists based at least in part upon the internal temperature of the cooking chamber or the temperature of the cooking chamber exhaust gas stream sensed by the temperature sensor and, when an over-temperature condition exists, (b) automatically transmit on over-temperature alert, reduce a heat output of the of the one or more heating elements, stop the heat output of the one or more heating elements, or a combination thereof.

11. The outdoor cooking system of claim 10 further comprising:
the cooking chamber having a vent opening for the cooking chamber exhaust gas stream and
the temperature sensor being located in the vent opening or in the cooking chamber exhaust gas stream within the cooking chamber upstream of the vent opening.

12. The outdoor cooking system of claim 11 further comprising the temperature sensor being attached to an interior side of an upwardly extending back wall of the cooker housing at an elevation which is higher than the food support structure.

13. The outdoor cooking system of claim 11 wherein the vent opening comprises one or more slots or louvers in an upwardly extending back wall of the cooker housing.

14. The outdoor cooking system of claim 11 wherein the vent opening comprises a gap between (a) an upper end of an upwardly extending back wall of the cooker housing and (b) a lower end of a back wall of the lid.

15. The outdoor cooking system of claim 10 wherein:
the one or more heating elements are a plurality of gas fuel burners or burner elements, each of the gas fuel burners or burner elements having a gas fuel inlet which includes a manual control valve;
the outdoor cooking system further comprises a gas fuel supply conduit which supplies a gas fuel to the gas fuel inlets of the gas fuel burners or burner elements and an over-temperature valve in the gas fuel supply conduit upstream of all of the manual control valves; and
when, in accordance with the programmed procedure of the program code embodied on the computer readable storage component, the control unit determines that an over-temperature condition exists, the programmed procedure causes the control unit to automatically operate to partially close or fully close the over-temperature valve.

16. The outdoor cooking system of claim 15 wherein when, in accordance with programmed procedure of the program code embodied on the computer readable storage component, the control unit determines that an over-temperature condition exists, the programmed procedure causes the control unit to automatically operate to fully close the over-temperature valve.

17. The outdoor cooking system of claim 15 wherein the over-temperature valve is an electric solenoid valve.

18. The outdoor cooking system of claim 10 wherein:
the one or more heating elements are a plurality of gas fuel burners or burner elements, each of the gas fuel burners or burner elements having a gas fuel inlet which includes an over-temperature valve and
when, in accordance with the programmed procedure of the program code embodied on the computer readable storage component, the control unit determines that an over-temperature condition exists, the programmed procedure causes the control unit to automatically operate to partially close or fully close the over-temperature valves of the plurality of gas fuel burners or burner elements.
